(19) United States
(12) Patent Application Publication
(10) Pub. No.: US 2026/0059285 A1
(43) Pub. Date: Feb. 26, 2026

(54) ELECTRONIC DEVICE, METHOD OF OPERATION ELECTRONIC DEVICE, AND SYSTEM INCLUDING ELECTRONIC DEVICE

(71) Applicant: Samsung Electronics Co., Ltd., Suwon-si (KR)

(72) Inventors: Boyoun PARK, Suwon-si (KR); Chungwoo PARK, Suwon-si (KR); Changyong PARK, Suwon-si (KR)

(73) Assignee: Samsung Electronics Co., Ltd., Suwon-si (KR)

(21) Appl. No.: 19/194,614

(22) Filed: Apr. 30, 2025

(30) Foreign Application Priority Data
Aug. 20, 2024 (KR) 10-2024-011627

(51) Int. Cl. H04W 4/90; H04W 4/44; H04W 52/02

(52) U.S. Cl. CPC H04W 4/90; H04W 4/44; H04W 52/0251

(57) ABSTRACT

An electronic device includes an interface module configured to convert a first signal received from a vehicle device into data and transmit the data to a controller, a temperature sensor configured to measure a temperature of the electronic device, an emergency call module configured to receive an emergency call request from the vehicle device, and the controller configured to receive the data from the interface module. The controller is configured to control data transmission of the interface module, based on the temperature and the emergency call request.

### CROSS-REFERENCE TO RELATED APPLICATION

This application is based on and claims priority under 35 U.S.C. § 119 to Korean Patent Application No. 10-2024-0111627, filed on Aug. 20, 2024, in the Korean Intellectual Property Office, the disclosure of which is incorporated by reference herein in its entirety.

### BACKGROUND

Example embodiments of the inventive concepts relate to an electronic device, and more particularly, to an electronic device which may provide an operation for reducing heat generation in an emergency call situation.

With the development of communication technology and vehicle technology, research is advancing in the field of telematics, which may provide various services such as emergency rescue, Internet services to vehicle drivers through wireless communication networks, and vehicle internal communication systems.

In particular, among telematics functions, an emergency call function, which requests emergency rescue due to a vehicle accident, may need to perform a successful operation normally even when a vehicle environment is abnormal, and a desire for technology to ensure that telematics systems operate normally in various situations is increasing.

### SUMMARY

Example embodiments of the inventive concepts provide an electronic device that controls an amount of heat generation so that a vehicle communication system may operate normally even in an abnormal environment.

According to some example embodiments of the inventive concepts, there is provided an electronic device including an interface module configured to convert a first signal received from a vehicle device into data and transmit the data to a controller, a temperature sensor configured to measure a temperature of the electronic device, an emergency call module configured to receive an emergency call request from the vehicle device, and the controller configured to receive the data from the interface module. The controller is configured to control data transmission of the interface module, based on the temperature and the emergency call request.

According to some example embodiments of the inventive concepts, there is provided a method of operating an electronic device supporting a telematics function, the method including measuring a temperature of the electronic device, receiving an emergency call request from a vehicle device, and converting a first signal received from the vehicle device into a first data, and transmitting the first data to a controller of the electronic device. The transmitting of the first data comprises controlling a transmission speed of the first data, based on the temperature and the emergency call request.

According to some example embodiments of the inventive concepts, there is provided a telematics system including at least one processor, an interface device configured to convert a signal received from a vehicle device into data and transmit the data to the at least one processor above, and a memory connected to the at least one processor and configured to store instructions for communicating with the vehicle device. Based on the instructions for communicating with the vehicle device, the at least one processor is configured to measure a temperature of the at least one processor, receive an emergency call request from the vehicle device, and control a data transmission of the interface device based on the temperature and the emergency call request.

### BRIEF DESCRIPTION OF THE DRAWINGS

Example embodiments will be more clearly understood from the following detailed description taken in conjunction with the accompanying drawings in which:

FIG. 1 is a block diagram illustrating an electronic device according to some example embodiments;

FIG. 2 is a block diagram for describing an emergency call according to some example embodiments;

FIG. 3 is a block diagram for describing data transmission speed control according to some example embodiments;

FIG. 4 is a block diagram for describing power control according to some example embodiments;

FIG. 5 is a block diagram for describing signal transmission speed control according to some example embodiments;

FIG. 6 is a diagram illustrating an example of data transmission speed control according to some example embodiments;

FIG. 7 is a flowchart illustrating a control method according to some example embodiments;

FIG. 8 is a flowchart illustrating a method of controlling a data transmission speed, according to some example embodiments;

FIG. 9 is a flowchart illustrating an example of a method of controlling a data transmission speed, according to some example embodiments; and

FIG. 10 is a block diagram illustrating a telematics system according to some example embodiments.

### DETAILED DESCRIPTION

Hereinafter, some example embodiments of the inventive concepts will be described in detail with reference to the accompanying drawings.

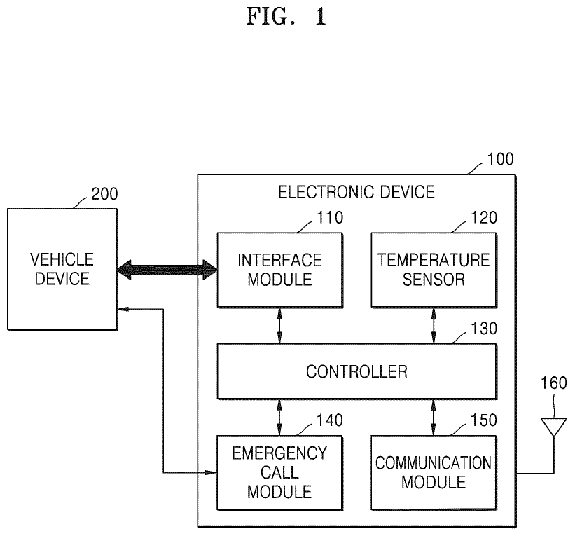

FIG. 1 is a block diagram illustrating an electronic device 100 according to some example embodiments.

The electronic device 100 according to some example embodiments may be provided in an electronic device, included in a vehicle, to perform a telematics function. The electronic device 100 may be provided in an electronic device as a component in vehicles, furniture, manufacturing facilities, doors, and various measurement devices.

Referring to FIG. 1, the electronic device 100 may include an interface module 110, a temperature sensor 120, a controller 130, an emergency call module 140, a communication module 150, and an antenna 160, and may communicate with a vehicle device 200 (e.g., a vehicle controller).

The interface module 110 may be a module for supporting communication between the vehicle device 200 and the electronic device 100. For example, the interface module 110 may support communication between the vehicle device 200 included in the vehicle and the electronic device 100 through Ethernet communication. In some example embodiments, the interface module 110 may include a physical layer that transmits and receives a physical signal in communication. The interface module 110 may convert an analog signal into a digital signal through the physical layer and transmit the digital signal, or may convert the digital signal into an analog signal and transmit the analog signal. More specifically, the interface module 110 may convert a signal (e.g., the analog signal) received from the vehicle device 200 (e.g., the vehicle controller) into digital data and transmit the digital data to the inside of the electronic device 100 (e.g., the controller 130). In addition, the interface module 110 may convert the digital data generated inside of the electronic device 100 (e.g., the controller 130) into analog signals and transmit the analog signals to the vehicle device 200. In some example embodiments, the interface module 110 may provide various interfaces such as Media Independent Interface (MII), Reduced Media Independent Interface (RMII), Gigabit Media Independent Interface (GMII), etc. for transmission and reception of signals and data. That is, the interface module 110 may provide various interfaces so that the electronic device 100 may be connected to the vehicle device 200 (e.g., the vehicle controller), and may include various types of connectors.

The modules and the term ‘module’ used below refer to software or hardware components such as a Field Programmable Gate Array (FPGA) or an Application Specific Integrated Circuit (ASIC), and the ‘module’ may perform certain roles. However, the ‘module’ is not limited to software or hardware. The ‘module’ may be configured to be in an addressable storage medium, or may be configured to execute one or more processors. Thus, as an example, the ‘module’ may include components such as software components, object-oriented software components, class components, and task components, processes, functions, attributes, procedures, subroutines, segments of program code, drivers, firmware, microcode, circuits, data, databases, data structures, tables, arrays, and variables. The functions provided within the components and ‘modules’ may be combined into a smaller number of components and ‘modules’ or may be further separated into additional components and ‘modules’.

The temperature sensor 120 may measure the temperature of the electronic device 100 or the components included in the electronic device 100. For example, the temperature sensor 120 may measure the temperature of the controller 130 or the temperature of the electronic device 100 itself. The temperature sensor 120 may operate inside the electronic device 100 or may be separately installed outside the electronic device 100 to transmit the measured data to the electronic device 100. In some example embodiments, the temperature sensor 120 may transmit the periodically measured temperature to the controller 130 and support a monitoring function, or may generate an event signal when the temperature exceeds a threshold temperature and transmit the event signal to the controller 130. Alternatively, when receiving a separate request from the controller 130, the temperature sensor 120 may measure the temperature and provide the measured temperature to the controller 130.

The emergency call module 140 may determine whether a traffic accident has occurred through interworking with various sensors and a global positioning system (GPS) device. The emergency call module 140 may automatically determine whether an accident has occurred based on information (e.g., vehicle external object information, impact force, etc.) received from a sensor and/or vehicle information received from the vehicle, and, when it is determined that the accident has occurred, may generate an emergency call request, and transmit the emergency call request to the controller 130.

In some example embodiments, the emergency call module 140 may receive an emergency call request notifying the occurrence of the accident from the vehicle device 200 (e.g., the vehicle controller). For example, the emergency call module 140 may communicate with the vehicle device 200 through inter-integrated circuit (I2C) communication. The emergency call module 140 may transmit the received emergency call request to the controller 130. Alternatively, the emergency call module 140 may receive a confirmation request for the emergency call request from the controller 130 and transmit whether the emergency call request has occurred to the controller 130 in response thereto. The emergency call module 140 is separately outside the controller 130 in some example embodiments, but the emergency call module 140 is not limited to the present example embodiments, and may be implemented inside the controller 130.

The controller 130 may control the overall operations of the electronic device 100 to provide the telematics function. The controller 130 may be electrically connected to the interface module 110, the temperature sensor 120, the emergency call module 140, the communication module 150, etc., to control the components, and may perform various operations to be described below.

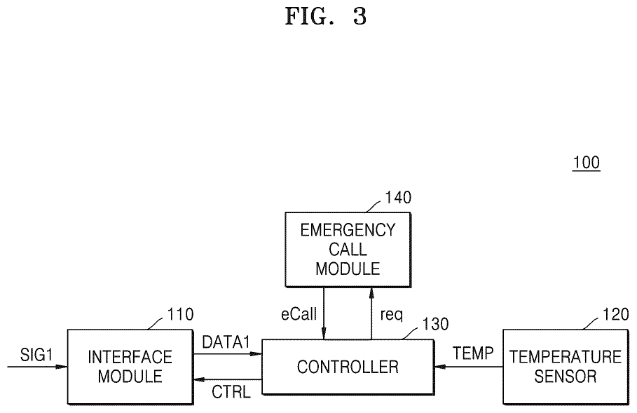

The controller 130 may control the transmission speed of data provided by the interface module 110 to the controller 130, based on the temperature measured by the temperature sensor 120 and whether the emergency call request has occurred. For example, the temperature of each of the electronic device 100 and the vehicle device 200 may increase due to the occurrence of a vehicle accident, etc., and the emergency call request may occur (or the electronic device 100 may receive the emergency call request from the vehicle device 200). At this time, the controller 130 may reduce the amount of heat generation of the electronic device 100 by limiting (reducing) the transmission speed of signals and/or data in order to provide a normal function (or an essential function) in an abnormal environment (e.g., an increase in the temperature due to the accident) such as the vehicle accident. This will be described in detail below with reference to FIGS. 3 to 6.

The communication module 150 may establish a direct communication channel or a wireless communication channel between the electronic device 100 and outside (e.g., a base station, a server, etc.), and support a communication function through the direct communication channel and the wireless communication channel. The communication module 150 may operate independently of the controller 130 (e.g., an application processor (AP)) and may include one or more communication processors (CPs) supporting direct or wireless communication. In some example embodiments, the communication module 150 may include a wireless communication module (e.g., a cellular communication module, a near field communication (NFC) module, or a global navigation satellite system (GNSS) communication module) or a wired communication module (e.g., a local area network (LAN) communication module, or a power line communication module). The communication module 150 may communicate with an external electronic device through a first network including a short-range communication network such as Bluetooth, WiFi direct, or infrared data association (IrDA), or a second network including a long-range communication network such as a cellular network, the Internet, or a computer network (e.g., a LAN or a wide area network (WAN)). These various types of communication modules 150 may be integrated into one component (e.g., a single chip), or may be implemented as a plurality of separate components (e.g., a plurality of chips). The wireless communication module may confirm and authenticate the electronic device 100 within a communication network such as the first network or the second network by using subscriber information (e.g., an international mobile subscriber identifier (IMSI)) stored in a subscriber identification module. The communication module 150 is separately outside the controller 130 in some example embodiments, but the communication module 150 is not limited to the example embodiments and may be implemented inside the controller 130.

The antenna 160 may transmit or receive a signal or power to or from the outside (e.g., a base station, a server, etc.) by the control of the communication module 150. In some example embodiments, the antenna 160 may include one antenna including a conductor formed on a substrate (e.g., a printed circuit board (PCB)) or a radiator having a conductive pattern. Meanwhile, the antenna 160 may include a plurality of antennas. At this time, at least one antenna suitable for a communication method used in the communication network such as the first network or the second network may be selected by the communication module 150. The signal or power may be transmitted or received between the communication module 150 and the outside through the at least one selected antenna.

The electronic device 100 according to some example embodiments may control the temperature by automatically controlling the transmission speed of signals and/or data in an abnormal environment due to a vehicle accident, etc. and reducing the amount of heat generation of the electronic device 100, thereby normally performing an essential function such as emergency rescue in various situations.

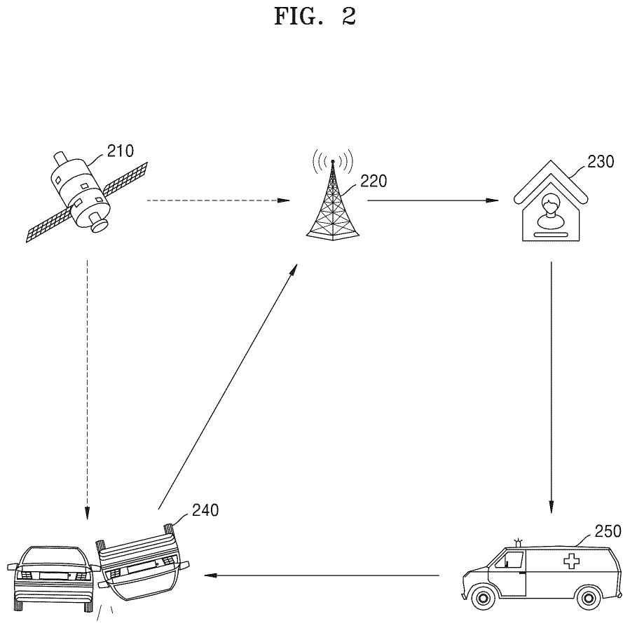

FIG. 2 is a diagram for describing an emergency call according to some example embodiments

Telematics may support smart home control, such as vehicle control and in-house device control, through a driver's smart terminal, based on a control module (e.g., the controller 130) and vehicle communication system (e.g., the communication module 150) installed in a vehicle. Telematics also may support vehicle remote control and condition management through communication with an Internet server, etc., and provide Internet information, including multimedia information, to a driver or another passenger in the vehicle.

Furthermore, in addition to a normal communication function, telematics may include an emergency call function of requesting emergency rescue by transmitting an accident location and accident-related information to an emergency rescue agency by the vehicle itself or manually in the event of a vehicle accident. Hereinafter, the emergency call function may be referred to as an emergency call request eCall.

As shown in FIG. 2, when an accident occurs to a vehicle 240 equipped with an emergency call system (e.g., a telematics system according to some example embodiments), the emergency call system itself may detect the accident and transmit the emergency call request eCall to notify that the accident requiring emergency rescue has occurred through the communication module installed in the vehicle 240 to a vehicle emergency call management system server 230 through a base station 220 The vehicle 240 equipped with the emergency call system may also transmit location information received from a GPS satellite 210 to the vehicle emergency call management system server 230. The vehicle emergency call management system server 230 may request an emergency call processing department 250 to dispatch an accident response team to a location of the vehicle 240. In some example embodiments, the vehicle 240 equipped with the emergency call system may transmit the emergency call request eCall to an emergency rescue agency when a vehicle accident such as a collision or a rear-end collision between vehicles or a vehicle rollover occurs. In addition, the vehicle 240 may automatically transmit data, such as a location of the accident, a vehicle type, a driving direction, automatic/manual reporting, a fuel type, whether seatbelts are worn, etc. to an emergency rescue agency near a place where the accident has occurred.

Meanwhile, telematics may use a multi-input multi-output (MIMO) antenna having a structure including at least one main antenna and an auxiliary antenna to improve communication performance. In addition, the emergency call system may be also configured to transmit the emergency call request eCall by selecting one of the main antenna and the auxiliary antenna according to a vehicle state in order to ensure a smooth operation of the emergency call function, even in the case of major vehicle damage such as vehicle rollover. In addition, because a frequency domain used in telematics may be different from a frequency domain used in an emergency call, an antenna for telematics may be different from an antenna for an emergency call system.

In particular, in the case of the emergency call request eCall, the emergency call system may need to operate in a higher temperature environment, such as excessive heat due to an accident, and the emergency call system may operate normally even in hot weather such as summer in a desert environment. For example, even in an environment where the vehicle or ambient temperature rises (rapidly) due to an accident, essential functions such as emergency call operations may need to be controlled to be performed.

Restated, the electronic device 100 according to some example embodiments may successfully perform an essential function (e.g., the emergency call request eCall) even in an abnormal environment (especially a higher temperature environment) through a temperature control operation, which controls the transmission speed of signals and/or data.

FIG. 3 is a block diagram describing data transmission speed control according to some example embodiments.

Referring to FIG. 3, the electronic device 100 may control the data transmission speed of the interface module 110, based on temperature data TEMP and the emergency call request eCall. As described above, the interface module 110 may receive a first signal SIG1, which is an analog signal, from a vehicle device (e.g., a vehicle controller), and may convert the first signal SIG1 into first data DATA1, which is digital data, and transmit the first data DATA1 to the controller 130.

The controller 130 may receive the temperature data TEMP including temperature information of the electronic device 100 and/or the controller 130 from the temperature sensor 120. The temperature sensor 120 may transmit the temperature data TEMP including the periodically measured temperature to the controller 130, or, when the temperature exceeds a threshold temperature, may transmit information about the temperature to the controller 130. In addition, the controller 130 may receive the emergency call request eCall from the emergency call module 140. When it is determined that an accident has occurred, the emergency call module 140 may generate and transmit the emergency call request eCall to the controller 130, or may receive the emergency call request eCall from the vehicle device 200 (e.g., a vehicle controller) and transmit the emergency call request eCall to the controller 130. In some example embodiments, when the temperature of the received temperature data TEMP is higher than the threshold temperature, the controller 130 may transmit a confirmation request req as to whether the emergency call request eCall has occurred to the emergency call module 140 in order to determine whether to perform a temperature control operation according to some example embodiments, and the emergency call module 140 may transmit the emergency call request eCall to the controller 130 in response thereto.

In some example embodiments, when the temperature of the received temperature data TEMP is higher than the threshold temperature, and the emergency call request eCall is received, the controller 130 may determine that the temperature control operation is required and reduce the data transmission speed of the interface module 110. More specifically, the controller 130 may transmit, to the interface module 110, a control signal CTRL for reducing the transmission speed of the first data DATA1 transmitted by the interface module 110 to the controller 130. In some example embodiments, the control signal CTRL may include information about a constraint frequency for reducing the data transmission speed. The interface module 110 may reduce the data transmission speed, which is a speed at which the first data DATA1 is transmitted to the controller 130, based on the received control signal CTRL.

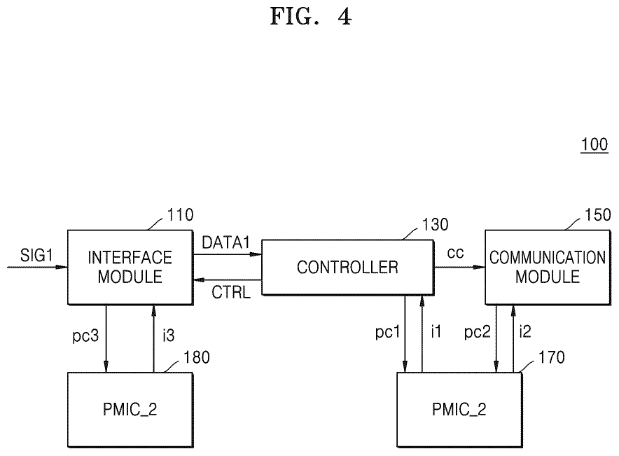

FIG. 4 is a block diagram for describing power control according to some example embodiments.

Referring to FIG. 4, the electronic device 100 may further include a first power management integrated circuit (PMIC) 170 and a second PMIC 180. The second PMIC 180 is separately from the first PMIC 170 in some example embodiments, but the first PMIC 170 and the second PMIC 180 are not limited to some example embodiments, and may be implemented on the same circuit or chip. The descriptions of the components of FIG. 4 redundant with those of FIGS. 1 to 3 are omitted.

In some example embodiments, the interface module 110 may reduce the transmission speed of the first data DATA1, based on the control signal CTRL of the controller 130. Therefore, power consumed by the interface module 110 to transmit the first data DATA1 (e.g., power consumed by a transmitter driven for data transmission) may be reduced. Accordingly, the amount of heat generated due to a data transmission operation of the interface module 110 may be reduced. In addition, the interface module 110 may transmit a third power control signal pc3 corresponding to the reduced data transmission speed to the second PMIC 180, based on the control signal CTRL of the controller 130, and the second PMIC 180 may reduce a third current i3 provided to the interface module 110, based on the third power control signal pc3. Accordingly, an amount of heat generated when the second PMIC 180 supplies a current may also be reduced.

In some example embodiments, the transmission speed of the first data DATA1 is reduced through the control described above, and thus, power consumed by intellectual property (IP) (e.g., Ethernet reception IP) to receive the first data DATA1 from the controller 130 may be reduced. Accordingly, the amount of heat generated due to a data reception operation of the controller 130 may be reduced. In addition, the controller 130 may transmit a first power control signal pc1 corresponding to the reduced data transmission speed to the first PMIC 170, and the first PMIC 170 may reduce a first current i1 provided to the controller 130, based on the first power control signal pc1. Accordingly, the amount of heat generated when the first PMIC 170 supplies a current may also be reduced.

In some example embodiments, the controller 130 may transmit a communication control signal cc (e.g., an event signal) to the communication module 150, based on the temperature data TEMP and the emergency call request eCall. In response to the communication control signal cc, the communication module 150 may reduce a signal transmission/reception speed with the outside (e.g., a base station, a server, etc.) in order to reduce heat generation of the electronic device 100. Accordingly, the amount of heat generated due to a signal transmission/reception operation of the communication module 150 may be reduced. In addition, the communication module 150 may transmit a second power control signal pc2 corresponding to the reduced signal transmission/reception speed to the first PMIC 170, and the first PMIC 170 may reduce a second current i2 provided to the communication module 150, based on the second power control signal pc2. Accordingly, an amount of heat generated when the first PMIC 170 supplies a current may also be reduced.

In some example embodiments, the first PMIC 170 and the second PMIC 180 may be implemented on the same PMIC, and in this case, the controller 130 may transmit power control signals to the same PMIC to perform a control operation on the first current i1, the second current i2, and/or the third current i3. In addition, in some example embodiments, a PMIC supplying the first current i1 consumed by the controller 130 and a PMIC supplying the second current i2 consumed by the communication module 150 may be implemented as separate circuits.

Restated, the electronic device 100 according to some example embodiments may reduce the supplied current by controlling the transmission speed of data received from a vehicle and the signal transmission/reception speed for communicating with the outside, and thus, the amount of heat generation may be reduced by reducing power consumed by the electronic device 100, thereby reducing the temperature of the electronic device 100.

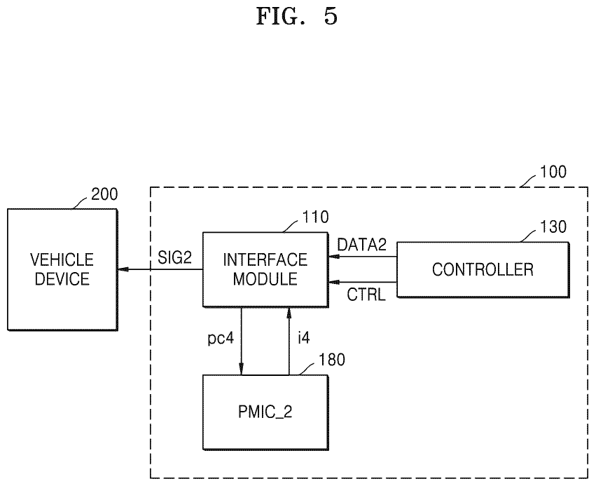

FIG. 5 is a block diagram for describing signal transmission speed control according to some example embodiments.

Referring to FIG. 5, the electronic device 100 may control the transmission speed of a second signal SIG2 transmitted to the vehicle device 200 (e.g., a vehicle controller). As described above, the interface module 110 may receive second data DATA2, which is digital data, generated by the controller 130, convert the second data DATA2 into the second signal SIG2, and transmit the second signal SIG2 to the vehicle device 200 (e.g., the vehicle controller).

In some example embodiments, when it is determined that a temperature control operation is required, the controller 130 may transmit, to the interface module 110, the control signal CTRL for reducing the transmission speed of the second signal SIG2 transmitted to the vehicle device 200. The interface module 110 may reduce a signal transmission speed for transmitting the second signal SIG2, based on the received control signal CTRL. Therefore, power consumed by the interface module 110 to transmit the second signal SIG2 may be reduced, and an amount of heat generated due to the signal transmission operation of the interface module 110 may be reduced. In addition, the interface module 110 may transmit a fourth power control signal pc4 corresponding to the reduced signal transmission speed to the second PMIC 180, and the second PMIC 180 may reduce a fourth current i4 provided to the interface module 110, based on the fourth power control signal pc4. Accordingly, an amount of heat generated when the second PMIC 180 supplies a current may also be reduced.

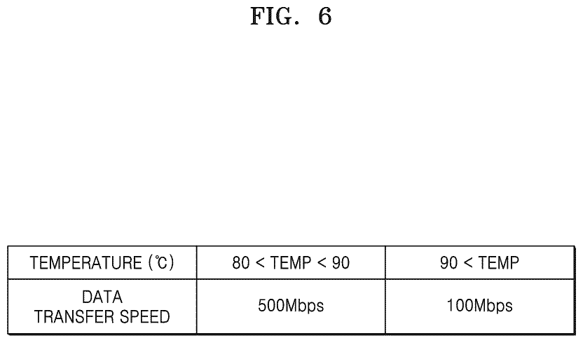

FIG. 6 is a diagram illustrating an example of data transmission speed control according to some example embodiments.

Referring to FIG. 6, the electronic device 100 may gradually reduce a data transmission speed in stages according to the temperature data TEMP. In some example embodiments, even though the temperature of the temperature data TEMP received by the controller 130 from the temperature sensor 120 is higher than a first threshold temperature (e.g., 80 degrees) and lower than a second threshold temperature (e.g., 90 degrees), the data transmission speed may be controlled to a relatively high speed (e.g., 500 Mbps) (e.g., lower than the data transmission speed (1 Gbps) when the temperature is normal), in order to reduce and/or prevent the performance of the electronic device 100 from rapidly deteriorating due to excessive constraints on the data transmission speed. When the temperature of the temperature data TEMP received by the controller 130 from the temperature sensor 120 is higher than the second threshold temperature, the amount of heat generation may be reduced by controlling the data transmission speed to a relatively low speed (e.g., 100 Mbps), in order to perform an essential function of the electronic device 100, even in an abnormal environment such as a rapid temperature increase.

The electronic device 100 according to some example embodiments may more precisely control the amount of heat generation according to a vehicle environment by controlling the transmission speed of signals and/or data in stages according to a degree of increase in the temperature.

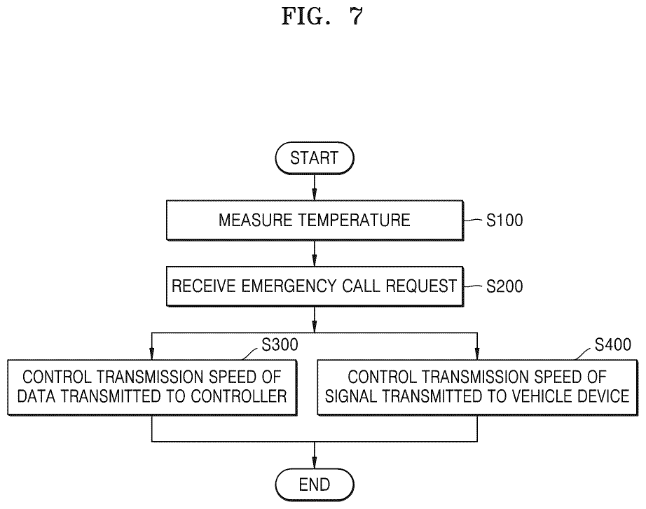

FIG. 7 is a flowchart illustrating a control method according to some example embodiments.

Referring to FIG. 7, a method of operating the electronic device 100 may control the amount of heat generation, based on the temperature data TEMP and the emergency call request eCall.

In operation S100, the controller 130 may receive the temperature data TEMP including information about the temperature of the electronic device 100 and/or the controller 130 measured by the temperature sensor 120. The controller 130 may periodically receive the temperature data TEMP of the electronic device 100 from the temperature sensor 120, or when the temperature exceeds a threshold temperature, the temperature sensor 120 may transmit information about the temperature to the controller 130.

In operation S200, the controller 130 may receive the emergency call request eCall from the emergency call module 140. The emergency call module 140 may determine for itself whether an accident has occurred based on various sensors, etc. and transmit the occurrence of the accident to the controller 130, or when receiving the emergency call request eCall notifying the occurrence of the accident from the vehicle device 200 (e.g., a vehicle controller), may transmit the emergency call request eCall to the controller 130 in response thereto.

In operation S300, the interface module 110 may transmit the first data DATA1 obtained by converting the first signal SIG1 received from the vehicle device 200 (e.g., the vehicle controller) to the controller 130. The controller 130 may control the transmission speed of the first data DATA1 transmitted by the interface module 110 to the controller 130 by transmitting the control signal CTRL to the interface module 110, based on the temperature data TEMP and the emergency call request eCall.

In operation S400, the interface module 110 may transmit the second signal SIG2 obtained by converting the second data DATA2 generated by the controller 130 to the vehicle device 200 (e.g., the vehicle controller). The controller 130 may control the transmission speed of the second signal SIG2 transmitted by the interface module 110 to the vehicle device 200 by transmitting the control signal CTRL to the interface module 110, based on the temperature data TEMP and the emergency call request eCall.

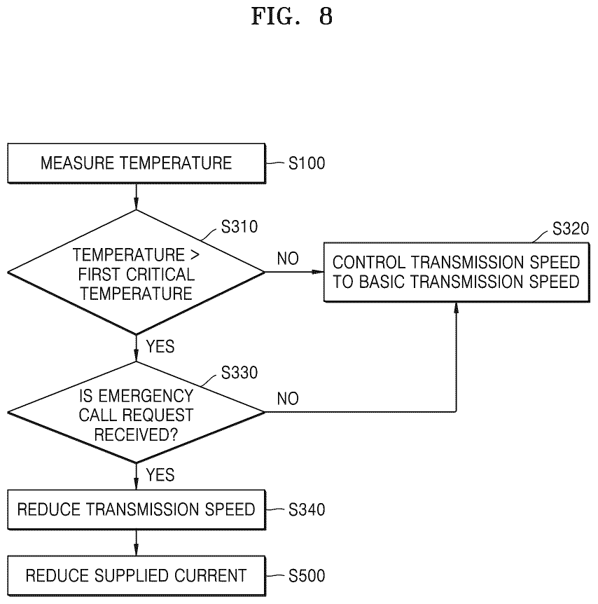

FIG. 8 is a flowchart illustrating a method of controlling a data transmission speed, according to some example embodiments.

Referring to FIG. 8, a method of operating the electronic device 100 may reduce the amount of heat generated by the electronic device 100 according to environmental conditions. In operation S100, the controller 130 may receive the temperature data TEMP including information about the measured temperature.

In operation S310, the controller 130 may determine whether the temperature of the temperature data TEMP is higher than a first threshold temperature. When the temperature of the temperature data TEMP is lower than or equal to or substantially equal to the first threshold temperature (No in operation S310), the controller 130 may determine that a vehicle environment is a normal and maintain the data transmission speed at a basic speed in operation S320. When the temperature of the temperature data TEMP is higher than the first threshold temperature (Yes in operation S310), the controller 130 may confirm whether the emergency call request eCall is received in operation S330. When the emergency call request eCall is not received (or when the emergency call request eCall does not occur) (No in operation S330), the controller 130 may determine that it is not an emergency situation such as a vehicle accident and maintain the data transmission speed at the basic speed in operation S320.

Furthermore, when the emergency call request eCall is received (or when the emergency call request eCall occurs) (Yes in operation S330), the controller 130 may determine that the temperature increases due to an emergency situation such as a vehicle accident. Therefore, in order to reduce the amount of heat generation of the electronic device 100, the controller 130 may reduce a data transmission speed, which is the speed at which the interface module 110 transmits the first data DATA1 to the controller 130, in operation S340. In operation S500, the interface module 110 may transmit power control signals corresponding to the reduced data transmission speed to a PMIC, and accordingly reduce power consumed and current supplied for data transmission, thereby reducing the amount of heat generation of the electronic device 100.

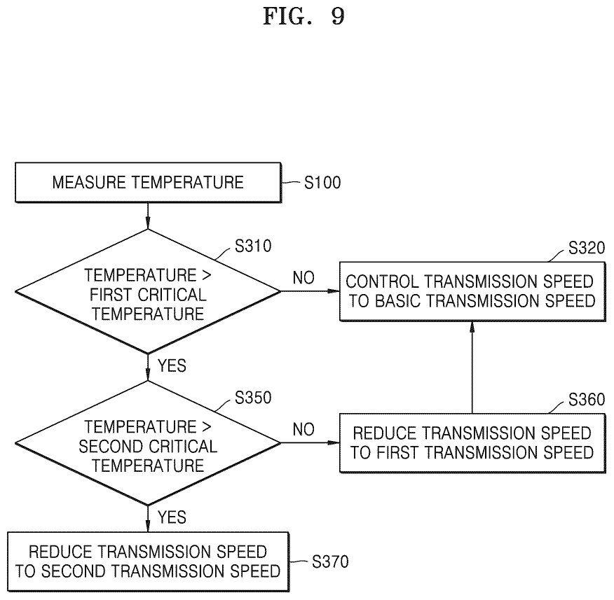

FIG. 9 is a flowchart illustrating an example of a method of controlling a data transmission speed, according to some example embodiments.

Referring to FIG. 9, a method of operating the electronic device 100 may control a data transmission speed in stages according to a degree of increase in the temperature. In operation S100, the controller 130 may receive the temperature data TEMP including information about measured temperature. In operation S310, the controller 130 may determine whether the temperature of the temperature data TEMP is higher than a first threshold temperature. When the temperature of the temperature data TEMP is lower than or equal to or substantially equal to the first threshold temperature (No in operation S310), the controller 130 may determine that a vehicle environment is a normal and maintain the data transmission speed at a basic speed in operation S320.

When the temperature of the temperature data TEMP is higher than the first threshold temperature (YES in operation S310), the controller 130 may determine whether the temperature of the temperature data TEMP is higher than a second threshold temperature in operation S350. When the temperature of the temperature data TEMP is lower than or equal to or substantially equal to the second threshold temperature (NO in operation S350), the controller 130 may reduce the data transmission speed to a relatively high first transmission speed in operation S360 in order to reduce and/or prevent the performance of the electronic device 100 from rapidly deteriorating due to excessive constraints on the data transmission speed. Restated, when the temperature of the temperature data TEMP is higher than the second threshold temperature (YES in operation S350), the amount of heat generation may be reduced by reducing the data transmission speed to a second transmission speed lower than the first transmission speed in operation S370, in order to perform an essential function of the electronic device 100, even in an abnormal environment such as a rapid temperature increase.

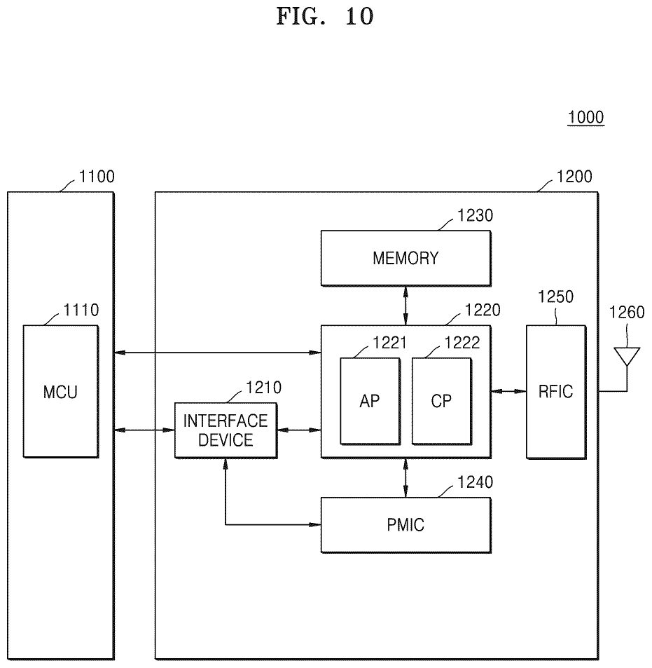

FIG. 10 is a block diagram illustrating a telematics system 1000 according to some example embodiments.

Referring to FIG. 10, the telematics system 1000 according to some example embodiments may include a vehicle system 1100 and a telematics device 1200. Here, the vehicle system 1100 may be a system including the vehicle device 200 described with reference to FIG. 1, the telematics device 1200 may correspond to the electronic device 100 described with reference to FIG. 1, and the telematics device 1200 may be provided in an electronic device such as a digital still camera, a digital video camera, a smartphone, a wearable device, an Internet of Things (IoT) device, a tablet personal computer (PC), a personal digital assistant (PDA), a portable multimedia player (PMP), a navigation device, etc.

The vehicle system 1100 may include a vehicle controller 1110. The vehicle controller 1110 may be implemented as a microcontroller unit (MCU).

The telematics device 1200 may include an interface device 1210 communicating between the vehicle controller 1110 of the vehicle system 1100 and the telematics device 1200, a telematics controller 1220 including a plurality of processors 1221 and 1222 controlling the overall operations of the telematics device 1200, a memory 1230, a PMIC 1240, a radio frequency integrated circuit (RFIC) 1250, and an antenna 1260. The interface device 1210 may correspond to the interface module 110 described with reference to FIG. 1, the telematics controller 1220 may correspond to the controller 130 described with reference to FIG. 1, and the PMIC 1240 may correspond to the first PMIC 170 and the second PMIC 180 described with reference to FIG. 4.

The interface device 1210 may be a device that supports Ethernet communication between the vehicle system 1100 and the telematics device 1200. The interface device 1210 may convert an analog signal received from the vehicle system 1100 into digital data and transmit the digital data to the telematics controller 1220, and convert to the digital data generated by the telematics controller 1220 into an analog signal and transmit the analog signal to the vehicle system 1100.

The telematics controller 1220 may be implemented as a system-on-chip (SoC), and may include an AP 1221 and a CP 1222. Here, the CP 1222 may correspond to the communication module 150 described with reference to FIG. 1. The telematics controller 1220 may generate an emergency call request when it is determined that a vehicle accident has occurred through a sensor, etc., or may separately receive an emergency call request notifying the occurrence of the accident from the vehicle system 1100. The telematics controller 1220 may control the transmission speed of data transmitted by the interface device 1210 to the telematics controller 1220, based on the temperature of the telematics device 1200 and whether the emergency call request has occurred, and may control the transmission speed of a signal transmitted by the interface device 1210 to the vehicle system 1100.

The memory 1230 may store a variety of data used by the plurality of processors 1221 and 1222. The memory 1230 may be connected to the plurality of processors 1221 and 1222 to store instructions executed by the plurality of processors 1221 and 1222 to communicate with the vehicle system 1100. In some example embodiments, the memory 1230 may be implemented as a volatile memory such as dynamic random access memory (DRAM) or static random access memory (SRAM), or a non-volatile memory such as Resistive RAM (ReRAM), phase-change RAM (PRAM), or NAND flash. The memory 1230 may be implemented as a memory card (a multi-media card (MMC), an embedded multi-media card (eMMC), a secure digital (SD) card, or a micro SD), etc.

The PMIC 1240 may adjust a voltage and/or current provided to the interface device 1210 and each of the plurality of processors 1221 and 1222, based on power control signals corresponding to the transmission speed of the controlled data received from the interface device 1210 and each of the plurality of processors 1221 and 1222 and the transmission speed of the signal. The RFIC 1250 may perform various wireless communication functions through the antenna 1260.

In other words, the telematics system 1000 according to some example embodiments may control the transmission speed of data received from a vehicle, the transmission speed of a signal transmitted to the vehicle, and the transmission/reception speed of a signal to communicate with the outside, thereby reducing current consumed and the amount of heat generated by the telematics device 1200.

One or more of the elements disclosed above may include or be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

While some example embodiments of the inventive concepts has been particularly shown and described with reference to example embodiments thereof, it will be understood that various changes in form and details may be made therein without departing from the spirit and scope of the following claims.

What is claimed is:

1. An electronic device comprising:
an interface module configured to convert a first signal received from a vehicle device into data and transmit the data to a controller;
a temperature sensor configured to measure a temperature of the electronic device;
an emergency call module configured to receive an emergency call request from the vehicle device; and
the controller configured to receive the data from the interface module,
wherein the controller is configured to control data transmission of the interface module, based on the temperature and the emergency call request.

2. The electronic device of claim 1, wherein the controller is configured to control the interface module to reduce a data transmission speed of the interface module to a reduced data transmission speed in response to the temperature being higher than a first threshold temperature.

3. The electronic device of claim 2, wherein
the controller is configured to transmit a constraint frequency to the interface module, and
the interface module is configured to further reduce the reduced data transmission speed based on the constraint frequency.

4. The electronic device of claim 1, wherein the controller is configured to confirm whether the emergency call module has received the emergency call request in response to the temperature being higher than a first threshold temperature.

5. The electronic device of claim 3, further comprising:
a first power management circuit (PMIC) configured to provide a first current to the controller,
wherein the controller is configured to control the first PMIC to reduce the first current based on the reduced data transmission speed.

6. The electronic device of claim 2, further comprising:
a second PMIC configured to provide a current to the interface module,
wherein the interface module is configured to control the second PMIC to reduce the current based on the reduced data transmission speed.

7. The electronic device of claim 5, further comprising:
a communication module configured to control a channel communicating outside,
wherein the first PMIC is configured to provide a second current to the communication module, and
the communication module is configured to control the first PMIC to reduce the second current based on a control signal of the controller.

8. The electronic device of claim 1, wherein
the interface module is further configured to convert the data received from the controller into a second signal and transmit the second signal to the vehicle device, and
the controller is further configured to control a signal transmission of the interface module, based on the temperature and the emergency call request.

9. The electronic device of claim 2, wherein the controller is configured to
reduce the data transmission speed to a first transmission speed in response to the temperature being higher than the first threshold temperature and lower than or equal to a second threshold temperature,
reduce the data transmission speed to a second transmission speed, the second transmission speed being lower than the first transmission speed, in response to the temperature being higher than the second threshold temperature.

10. A method of operating an electronic device supporting a telematics function, the method comprising:
measuring a temperature of the electronic device;
receiving an emergency call request from a vehicle device; and
converting a first signal received from the vehicle device into a first data; and
transmitting the first data to a controller of the electronic device,
wherein the transmitting of the first data comprises
controlling a transmission speed of the first data, based on the temperature and the emergency call request.

11. The method of claim 10, wherein
the controlling of the transmission speed includes reducing the transmission speed of the first data to a reduced transmission speed in response to the temperature being higher than a first threshold temperature.

12. The method of claim 11, wherein the transmitting of the first data includes reducing a current supplied to transmit the first data, based on the reduced transmission speed.

13. The method of claim 10, further comprising:
converting a second data generated by the controller into a second signal and transmitting the second signal to the vehicle device,
wherein the transmitting of the second signal includes controlling a transmission speed of the second signal based on the temperature and the emergency call request.

14. The method of claim 11, wherein
the controlling the transmission speed includes
reducing the transmission speed of the first data to a first transmission speed in response to the temperature being higher than the first threshold temperature and lower than or equal to a second threshold temperature, and
reducing the transmission speed of the first data to a second transmission speed lower than the first transmission speed in response to the temperature being higher than the second threshold temperature.

15. A telematics system comprising:
at least one processor;
an interface device configured to convert a signal received from a vehicle device into data and transmit the data to the at least one processor above; and
a memory connected to the at least one processor and configured to store instructions for communicating with the vehicle device,
wherein based on the instructions for communicating with the vehicle device, the at least one processor is configured to
measure a temperature of the at least one processor,
receive an emergency call request from the vehicle device, and
control a data transmission of the interface device based on the temperature and the emergency call request.

16. The telematics system of claim 15, wherein the at least one processor is configured to reduce a data transmission speed of the interface device to a reduced data transmission speed in response to the temperature being higher than a first threshold temperature.

17. The telematics system of claim 16, wherein the at least one processor is configured to reduce a current provided to the at least one processor based on the reduced data transmission speed.

18. The telematics system of claim 16, wherein the at least one processor is configured to reduce a current provided to the interface device based on the reduced data transmission speed.

19. The telematics system of claim 15, wherein
the interface device is configured to convert the data received from the at least one processor into a second signal and transmit the second signal to the vehicle device, and
the at least one processor is configured to control a signal transmission of the interface device based on the temperature and the emergency call request.

20. The telematics system of claim 16, wherein
the at least one processor is configured to
reduce the data transmission speed to a first transmission speed in response to the temperature being higher than the first threshold temperature and lower than or equal to a second threshold temperature, and
reduce the data transmission speed to a second transmission speed, the second transmission speed being lower than the first transmission speed, in response to the temperature being higher than the second threshold temperature.
